(19) United States
(12) Patent Application Publication
(10) Pub. No.: US 2023/0385370 A1
(43) Pub. Date: Nov. 30, 2023

(54) METHOD AND APPARATUS FOR COMPUTATION ON CONVOLUTIONAL LAYER OF NEURAL NETWORK

(71) Applicant: Novatek Microelectronics Corp., Hsinchu (TW)

(72) Inventors: Po-Wei Chen, Kaohsiung City (TW); Chieh-Cheng Chen, Changhua County (TW)

(73) Assignee: Novatek Microelectronics Corp., Hsinchu (TW)

(21) Appl. No.: 17/827,811

(22) Filed: May 30, 2022

(51) Int. Cl. G06F 17/15; G06F 7/544; G06N 3/04

(52) U.S. Cl. CPC G06F 17/15; G06F 7/5443; G06N 3/0481

(57) ABSTRACT

A method and an apparatus for computation on a convolutional layer of a neural network are proposed. The apparatus includes an adder configured to receive a first sum of products, receive a pre-computed convolution bias of the convolutional layer, and perform accumulation on the first sum of products and the pre-computed convolution bias to generate an adder result of the convolutional layer, where the first sum of products is a sum of products of quantized input activation of the convolutional layer and quantized convolution weights of the convolutional layer, and where the pre-computed convolution bias is associated with a zero point of input activation of the convolutional layer and a zero point of output activation of the convolutional layer.

### TECHNICAL FIELD

The disclosure relates to a method and an apparatus for computation on a convolutional layer of a neural network.

### BACKGROUND

Quantization is primarily a technique to speed up the computation while a deep learning model is adopted. Quantization allows each parameter and activation in the deep learning model to be transformed to a fixed-point integer. On the other hand, de-quantization is required to transform a fixed-point value back to a floating-point value during convolution operation, or alternatively, a fixed-point value is required to be subtracted by a corresponding zero point (i.e. a fixed-point value corresponding to a floating-point zero) such that the floating-point zero corresponds to the fixed-point zero, and then multiplication in convolution operation is performed thereafter. However, floating-point multiplication is not supported by hardware and this results in an inapplicable approach to de-quantization. Moreover, since the range of an input activation is not assumed to be symmetric with respect to real value 0, additional bits are required for the input activation due to asymmetric quantization that is normally applied thereon.

### SUMMARY OF THE DISCLOSURE

A method and an apparatus for computation on a convolutional layer of a neural network are proposed.

According to one of the exemplary embodiments, the apparatus includes an adder configured to receive a first sum of products, receive a pre-computed convolution bias of the convolutional layer, and perform accumulation on the first sum of products and the pre-computed convolution bias to generate an adder result of the convolutional layer, where the first sum of products is a sum of products of quantized input activation of the convolutional layer and quantized convolution weights of the convolutional layer, and where the pre-computed convolution bias is associated with a zero point of input activation of the convolutional layer and a zero point of output activation of the convolutional layer.

According to one of the exemplary embodiments, the method includes to receive a first sum of products, receive a pre-computed convolution bias of the convolutional layer, and perform accumulation on the first sum of products and the pre-computed convolution bias to generate an adder result of the convolutional layer, where the first sum of products is a sum of products of quantized input activation of the convolutional layer and quantized convolution weights of the convolutional layer, and where the pre-computed convolution bias is associated with a zero point of input activation of the convolutional layer and a zero point of output activation of the convolutional layer.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of an apparatus for computation on a convolutional layer of a neural network in accordance with an exemplary embodiment of the disclosure.

FIG. 2 illustrates a flowchart of a method for computation on a convolutional layer of a neural network in accordance with an exemplary embodiment of the disclosure.

FIG. 3 illustrates a schematic diagram of an apparatus for computation on a convolutional layer of a neural network in accordance with another exemplary embodiment of the disclosure.

To make the above features and advantages of the application more comprehensible, several embodiments accompanied with drawings are described in detail as follows.

### DESCRIPTION OF THE EMBODIMENTS

To solve the prominent issue, some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

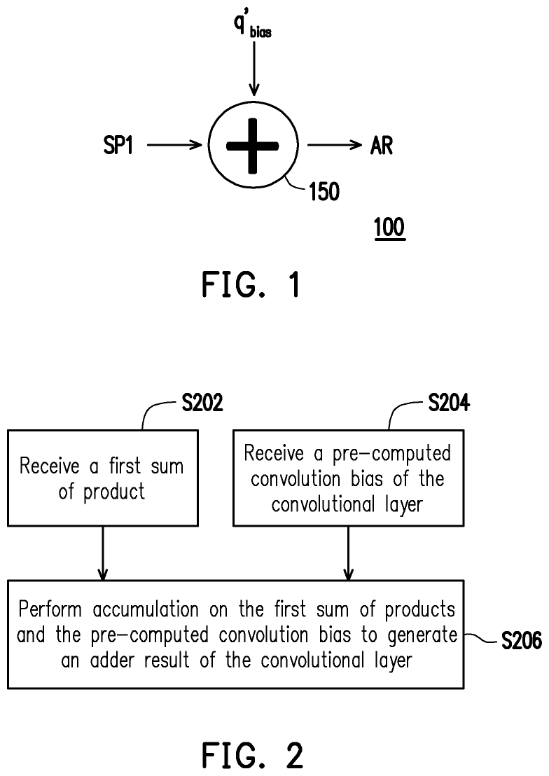

FIG. 1 illustrates a schematic diagram of an apparatus for computation on a convolutional layer of a neural network in accordance with an exemplary embodiment of the disclosure. All components and configurations of the apparatus are first introduced in FIG. 1. The functionalities of the components are disclosed in more detail in conjunction with FIG. 2.

Referring to FIG. 1, an apparatus 100 at least includes an adder 150. The adder 150 is configured to receive and perform accumulation on two inputs SP1 and q′_{bias} to generate an adder result AR.

FIG. 2 illustrates a flowchart of a method for computation on a convolutional layer of a neural network in accordance with an exemplary embodiment of the disclosure, where the steps of FIG. 2 could be implemented by the apparatus as illustrated in FIG. 1.

Referring to FIG. 1 in conjunction with FIG. 2, the adder 150 receives a first sum of products SP1 (Step S202), where the first sum of products SP1 is a sum of products of quantized input activation of the convolutional layer and quantized convolution weights of the convolutional layer. The adder 150 also receives a pre-computed convolution bias q′_{bias} of the convolutional layer, where the pre-computed convolution bias q′_{bias} is associated with a zero point of input activation of the convolutional layer and a zero point of output activation of the convolutional layer. Next, the adder 150 performs accumulation on the first sum of products SP1 and the pre-computed convolution bias q′_{bias} to generate an adder result AR of the convolutional layer (Step S206). Note that the computation of the zero points of the input activation and the output activation is merged into a quantized bias to generate the pre-computed convolution bias a/bias that can be computed offline. The implementation of the details may be demonstrated as follows along with an exemplary full derivation.

Denote rᵢₙ qᵢₙ, and zᵢₙ are respectively a floating-point input activation before quantization (i.e., an input activation to be quantized), a fixed-point quantized input activation, and a zero point with respect to the input activation. A quantized input activation qᵢₙ may be represented as follows:

$${q}_{in} = \frac{{r}_{in}}{{scale}_{in}} + {z}_{in}$$

Herein, scaleᵢₙ denotes a floating-point scale factor for the input activation to be quantized from floating-point values to integers and is also referred to as “a first scale factor” hereafter. As for asymmetric quantization of the input activation, scaleᵢₙ may be represented as follows:

$${scale}_{in} = \frac{max ( {r}_{i n} ) - min ( {r}_{i n} )}{{q}_{max} - {q}_{min}}$$

Note that qₘᵢₙ and qₘₐₓ respectively denote the minimum and the maximum of the quantized integer values. For example, if 8-bit quantization is performed, [qₘᵢₙ, qₘₐₓ] may be [−128,127 ] or [0, 255].

Quantized convolution weights q_{weight} may be represented as follows:

$${q}_{weight} = \frac{{r}_{weight}}{{scale}_{weight}} + {z}_{weight} \qquad Eq . ( 1 )$$

Herein, r_{weight}, q_{weight} and Z_{weight} are respectively a floating-point weight before quantization (i.e., a weight to be quantized), a fixed-point quantized weight, and a zero point with respect to the weight. scale_{weight} denotes a floating-point scale factor for convolution weights to be quantized from floating-point values to integers and is also referred to as “a second scale factor” hereinafter. As for symmetric quantization of the convolution weights, scale_{weight} may be represented as follows:

$${scale}_{weight} = \frac{max ( abs ( {r}_{weight} ) )}{{q}_{max}}$$

A quantized output activation gout may be represented as follows:

$${q}_{out} = \frac{{r}_{out}}{{scale}_{out}} + {z}_{out} \qquad Eq . ( 2 )$$

Herein, rₒᵤₜ, gₒᵤₜ, and zₒᵤₜ are respectively a floating-point output activation before quantization (i.e., an output activation to be quantized), a fixed-point quantized output activation, and a zero point with respect to the output activation. scaleₒᵤₜ denotes a floating scale factor for the output activation to be quantized from floating-point values to integers and is also referred to as “a third scale factor”. As for asymmetric quantization of the output activation, scaleₒᵤₜ may be represented as follows:

$${scale}_{o u t} = \frac{max ( {r}_{o u t} ) - min ( {r}_{o u t} )}{{q}_{max} - {q}_{min}}$$

Note that a quantized bias q_{bias} may be represented as follows:

$${q}_{b i a s} = \frac{{r}_{bias}}{{scale}_{bias}} = \frac{{r}_{bias}}{{scale}_{in} \times {scale}_{weight}} \qquad Eq . ( 3 )$$

Also, note that a floating output activation rₒᵤₜ may be represented as follows:

rₒᵤₜ=Σ(rᵢₙ×r_{weight})+r_{bias} Eq. (4)

By substituting the information in Eq.(1), Eq.(2), and Eq.(4) into Eq.(3), the quantized output activation gout in Eq.(3) may be rewritten as follows:

$$\begin{matrix}{q}_{out} = \frac{{r}_{out}}{{scale}_{out}} + {z}_{out} \\ = \frac{\sum ( {r}_{in} \times {r}_{weight} ) + {r}_{bias}}{{scale}_{out}} + {z}_{out} \\ = \frac{\sum [ ( ( {q}_{in} - {z}_{in} ) \times {scale}_{in} ) \times ( {q}_{weight} \times {scale}_{weight} ) ] + \\ ( {q}_{bias} \times {scale}_{in} \times {scale}_{weight} )}{{scale}_{out}} + {z}_{out} \\ = \frac{{scale}_{in} \times {scale}_{weight}}{{scale}_{out}} \times ( \sum [ ( {q}_{in} - {z}_{in} ) \times {q}_{weight} ] + {q}_{bias} ) + {z}_{out}\end{matrix} \qquad Eq . ( 5 )$$

It can be observed from Eq.(5) that, the quantized input activation is subtracted by a zero point such that the floating-point zero corresponds to the fixed-point zero, and the quantized input activation requires an additional 1-bit. If the input activation is quantized to n-bit and the convolution weights are quantized to m-bit, the result of the convolution multiplication requires (n+1)-bit×m-bit. To remedy such issue, the quantized output activation gout in Eq.(5) may be expanded and rearranged as follows:

$$\begin{matrix}{q}_{out} = \frac{{scale}_{in} \times {scale}_{weight}}{{scale}_{out}} \times [ \sum ( {q}_{in} \times {q}_{weight} ) - \sum ( {z}_{in} \times {q}_{weight} ) \\ + {q}_{bias} + \frac{{scale}_{out}}{{scale}_{in} \times {scale}_{weight}} \times {z}_{out} ] \\ = \frac{{scale}_{in} \times {scale}_{weight}}{{scale}_{out}} \times \vert \sum ( {q}_{in} \times {q}_{weight} ) + ( {q}_{biαs} - \\ \sum ( {z}_{in} \times {q}_{weight} ) ) + \frac{{scale}_{out}}{{scale}_{in} \times {scale}_{weight}} \times {z}_{out} ] \\ = \frac{{scale}_{in} \times {scale}_{weight}}{{scale}_{out}} \times [ \sum ( {q}_{in} \times {q}_{weight} ) + {q}_{bias}^{′} ]\end{matrix} \qquad Eq . ( 6 )$$

$$In particular , since {z}_{in} , {q}_{weight} and {z}_{out} are known , \qquad Eq . ( 7 )$$

$${q}_{bias}^{′} is able to be pre ‐ computed :$$

$${q}_{bias}^{′} = {q}_{bias} - \sum ( {z}_{in} \times {q}_{weight} ) + \frac{{scale}_{out}}{{scale}_{in} \times {scale}_{weight}} \times {z}_{out}$$

Therefore, no additional bit is a required for the computation of a zero point.

Moreover, it can be observed from Eq.(6) that, re-quantization adopts multiplication with a floating point

$$\frac{{scale}_{in} \times {scale}_{weight}}{{scale}_{out}} ,$$

which is not hardware friendly, and therefore

$$\frac{{scale}_{in} \times {scale}_{weight}}{{scale}_{out}}$$

may be approximated by multiplication operation with a multiplication factor req_mul and bit-shift operation with a bit-shift number req_shift, where req_mul and req_mul are both natural numbers. Therefore, the approximation of the quantized output activation go, may be expressed as follows, which does not involve floating-point multiplication:

qₒᵤₜ˜([Σ(qᵢₙ×q_{weight})+q′_{bias}]×req_mul)>>req_{shift} Eq. (8)

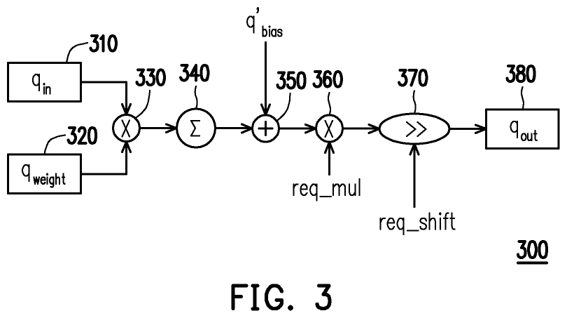

In practice, FIG. 3 illustrates a schematic diagram of an apparatus for computation on a convolutional layer of a neural network in accordance with another exemplary embodiment of the disclosure.

Referring to FIG. 3, an apparatus 300 at least includes a receiving circuit 310, a quantization circuit 320, a multiplication circuit 330, a summation circuit 340, an adder 350, a multiplier 360, a bit-shifter 370, and an output circuit 380.

The receiving circuit 310 is configured to receive an n-bit integer input as a quantized input activation qᵢₙ. Also, the quantization circuit 320 is configured to perform quantization on convolution weights to generate quantized convolution weights q_{weight}. The quantization circuit 320 may receive floating-point weights and symmetrically quantize the floating-point weights into m-bit integer weights.

The multiplication circuit 330 is configured to receive the quantized input activation qᵢₙ and the quantized convolution weights q_{weight} to generate multiplication results, and the summation circuit 340 is configured to receive and sum the multiplication results to generate a first sum of products, where the first sum of products corresponds to the term Σ(qᵢₙ×q_{weight}) in Eq.(8).

The adder 350, similar to the adder 150 in FIG. 1, is configured to receive the first sum of products and a pre-computed convolution bias q′_{bias} and perform accumulation on the first sum of products and the pre-computed convolution bias q′_{bias} to generate an adder result. Note that the adder result corresponds to the term Σ(qᵢₙ×q′_{weight})+q′_{bias} in Eq.(8).

Note that the pre-computed convolution bias q′_{bias} may be pre-computed through offline quantization based on a quantized bias, a zero point of the input activation, a zero point of the output activation, and the quantization convolution weights, where the quantized bias is in integer values scaled from a convolution bias in floating-point values. In the present exemplary embodiment, the pre-computed convolution bias may be computed according to Eq.(7). Up to this stage, each step only involves integer operations, and no additional bit is required for the computation of a zero point.

The multiplier 360 is configured to perform multiplication operation on the adder result with a multiplication factor req_mul to generate a multiplication result, and the bit-shifter 370 is configured to perform bit-shift operation with a bit-shift number req_shift on the multiplication result to generate a quantized output activation qₒᵤₜ. Herein, the multiplication with floating points adopted in re-quantization is replaced by the approximated value with the multiplication operation and the bit-shift operation. The quantized output activation gout is also a quantized input activation of a next convolutional layer of the neural network, and the output circuit 380 is configured to output the quantized output activation gout to the receiving circuit 310.

In view of the aforementioned descriptions, an effective quantization approach is proposed for computation on a convolutional layer of a neural network so as to ease the hardware burden.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An apparatus for computation on a convolutional layer of a neural network comprising:
an adder configured to:
receive a first sum of products, wherein the first sum of products is a sum of products of quantized input activation of the convolutional layer and quantized convolution weights of the convolutional layer;
receive a pre-computed convolution bias of the convolutional layer, wherein the pre-computed convolution bias is associated with a zero point of input activation of the convolutional layer and a zero point of output activation of the convolutional layer; and
perform accumulation on the first sum of products and the pre-computed convolution bias to generate an adder result of the convolutional layer.

2. The apparatus according to claim 1 further comprising:
a receiving circuit, configured to receive the quantized input activation; and
a quantization circuit, configured to perform quantization on the convolution weights to generate the quantized convolution weights.

3. The apparatus according to claim 1 further comprising:
a multiplication circuit, configured to multiply the quantized input activation and the quantized convolution weights to generate a plurality of multiplication results; and
a summation circuit, configured to sum the plurality of multiplication results to generate the first sum of products.

4. The apparatus according to claim 1,
wherein the pre-computed convolution bias is pre-computed based on a quantized bias of point of the output activation of the convolutional layer, and the quantized convolution weights, wherein the quantized bias is in integer values scaled from a convolutional bias in floating-point values.

5. The apparatus according to claim 4,
wherein pre-computed convolution bias is pre-computed based on the quantized bias, a second sum of products, and a scaling of the zero point of the output activation, wherein the second sum of products is a sum of products of the zero point of the input activation and the quantized convolution weights.

6. The apparatus according to claim 5,
wherein the scaling of the zero point of the output activation is associated with a first scale factor that quantizes the input activation from floating-point values to integer values, a second scale factor that quantizes the convolution weights from floating-point values to integer values, and a third scale factor that quantizes the output activation from floating-point values to integer values.

7. The apparatus according to claim 1 further comprising:
a multiplier, configured to perform multiplication on the adder result with a multiplication factor to generate a multiplier result; and
a bit-shifter, configured to perform bit-shift operation on the multiplier result with a bit-shift number to generate quantized output activation.

8. The apparatus according to claim 6,
wherein the quantized output activation of the convolutional layer is a quantized input activation of a next convolutional layer of the neural network.

9. A method for computation on a convolutional layer of a neural network comprising:
receiving a first sum of products, wherein the first sum of products is a sum of products of quantized input activation of the convolutional layer and quantized convolution weights of the convolutional layer;
receiving a pre-computed convolution bias of the convolutional layer, wherein the pre-computed convolution bias is associated with a zero point of input activation of the convolutional layer and a zero point of output activation of the convolutional layer; and
performing accumulation on the first sum of products and the pre-computed convolution bias to generate an adder result of the convolutional layer.

10. The method according to claim 9 further comprising:
receiving the quantized input activation; and
performing quantization on the convolution weights to generate the quantized convolution weights.

11. The method according to claim 9 further comprising:
multiplying the quantized input activation and the quantized convolution weights to generate a plurality of multiplication results; and
summing the plurality of multiplication results to generate the first sum of products.

12. The method according to claim 9,
wherein the pre-computed convolution bias is pre-computed based on a quantized bias of point of the output activation of the convolutional layer, and the quantized convolution weights, wherein the quantized bias is in integer values scaled from a convolutional bias in floating-point values.

13. The method according to claim 12,
wherein pre-computed convolution bias is pre-computed based on the quantized bias, a second sum of products, and a scaling of the zero point of the output activation, wherein the second sum of products is a sum of products of the zero point of the input activation and the quantized convolution weights.

14. The method according to claim 13,
wherein the scaling of the zero point of the output activation is associated with a first scale factor that quantizes the input activation from floating-point values to integer values, a second scale factor that quantizes the convolution weights from floating-point values to integer values, and a third scale factor that quantizes the output activation from floating-point values to integer values.

15. The method according to claim 9 further comprising:
performing multiplication on the adder result with a multiplication factor to generate a multiplier result; and
performing bit-shift operation on the multiplier result with a bit-shift number to generate quantized output activation.

16. The method according to claim 14,
wherein the quantized output activation of the convolutional layer is a quantized input activation of a next convolutional layer of the neural network.
